(19) United States
(12) Patent Application Publication
(10) Pub. No.: US 2010/0235493 A1
(43) Pub. Date: Sep. 16, 2010

(54) EXTENDABLE DISTRIBUTED NETWORK MANAGEMENT SYSTEM AND METHOD

(76) Inventors: Lawrence M. Besaw, Severance, CO (US); Bob Bethke, Fort Collins, CO (US); Brad Jones, Ft. Collins, CO (US); Srikanth Natarajan, Fort Collins, CO (US); Jacob Bastiaan Ven, Loveland, CO (US); Robert J. Wernsman, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/404,968

(22) Filed: Mar. 16, 2009

(51) Int. Cl. G06F 15/173

(52) U.S. Cl. 709/224

(57) ABSTRACT

An extendable network management system and method is provided to manage a network environment. The system can include a management server with a management application. In addition, the management application is configured to enable a user to manage the network environment. A extension application server can host a plurality of extension modules. The extension modules can supply management functions to the management application for defined network components. Further, a plurality of management engines can be located on the extension application server. The management engines can provide network probing and network event management, while integrating an extension modules' data object model with a management application's data object

### BACKGROUND

Modern computer networks are highly complex. Due to this overall complexity, there are many different device types, protocols, and services that need to be managed within large networks. It can be difficult for a single network management application to provide all the desired management functions for such expansive networks.

One network management solution is to provide a network management system or platform that provides the core management functionality but also allows extensions to provide additional management functions and content. Examples of the additional content include the management of MPLS, IP Telephony, Multi-Cast Streaming, performance management, and security management. These extensions can be embodied in extensions or SPIs (smart plug-ins) that are able to provide the additional network management tools and content. Such SPIs can be quite complex and include functionality similar to the network management system's functionality. For example, smart plug-ins (SPIs) can provide user interfaces (UIs), trap resolution, incident generation, discovery, state monitoring, causal analysis, and other similar functions for managing a complex network.

A network management system (NMS) is more valuable when the network management system makes the development of SPIs easier and more-cost effective. In addition, the content from the SPIs should appear to the end user as if the additionally supplied content is originating from the same network management application. An integration solution that scales well for large networks is also desirable, especially considering that there may be substantial processing and memory resource requirements used by each SPI and the network management application.

### BRIEF DESCRIPTION OF THE DRAWINGS

FIG. 1 is block diagram illustrating an embodiment of an extendable distributed network management system configured to manage a network environment;

FIG. 2 is block diagram illustrating an embodiment of an extendable distributed network management system configured to extend a network management application's user interface and event management capabilities;

FIG. 3 is a block diagram illustrating an extendable distributed network management system where each extension module is located on a separate extension application server; and

FIG. 4 is a flow chart illustrating a method for extending a network management application configured to manage a network environment in accordance with an embodiment.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

In prior systems, there have been various configurations of network management applications. One approach to an extensible network management application and system has been the tightly coupled approach. This involves sharing a common data model and data storage between the network management system and the extensions that provide additional functionality and content (e.g., SPIs). Tight coupling has the advantage of providing consistent data processing, consistent event processing, and a unified view of management information that is displayed to a system administrator. However, tight coupling has the drawback of producing a highly complex system that is difficult to develop and maintain due to the large number of inter-dependencies, etc. The reliability of the system can also be reduced as a result of the complexity. Furthermore, scalability issues can exist in tightly coupled systems because it is harder to distribute the processing of the SPIs from various content providers due to the tightly coupled nature of the system.

Another approach to a network management system is a variety of loosely-coupled network management systems. Such loosely-coupled systems are easier to develop and maintain but have problems providing a consistent management approach or a unified view of management data for system administrators. There may be unified data views in some areas, such as events, but not other areas, such as network inventory. These types of non-uniformity can make it difficult for a system administrator to navigate through the management system. For example, one species of such a system can provide alarm consolidation. However, an end user may not be able to see all the alarms together, or the end user cannot easily navigate from the alarms to a consolidated inventory. In some loosely coupled applications, there may be an attempt to provide a portal or some other form of loose UI integration, but there is no data-level integration and no unified view of the management data across all the management content. Another problem with this less strict approach is that each functional area of network management (UI, discovery, monitoring, events, causal analysis) is displayed, structured and/or performed differently by the various content providers and this can result in a lack of consistency in user interfaces, data output, and error resolution data.

The present system and method includes a scalable, distributed network management system that is generally loosely coupled while providing the advantages of a tightly coupled approach. Specifically, the system and method has a loosely coupled architecture while providing a unified and consistent view of network incidents, network nodes, inventory, and configurations.

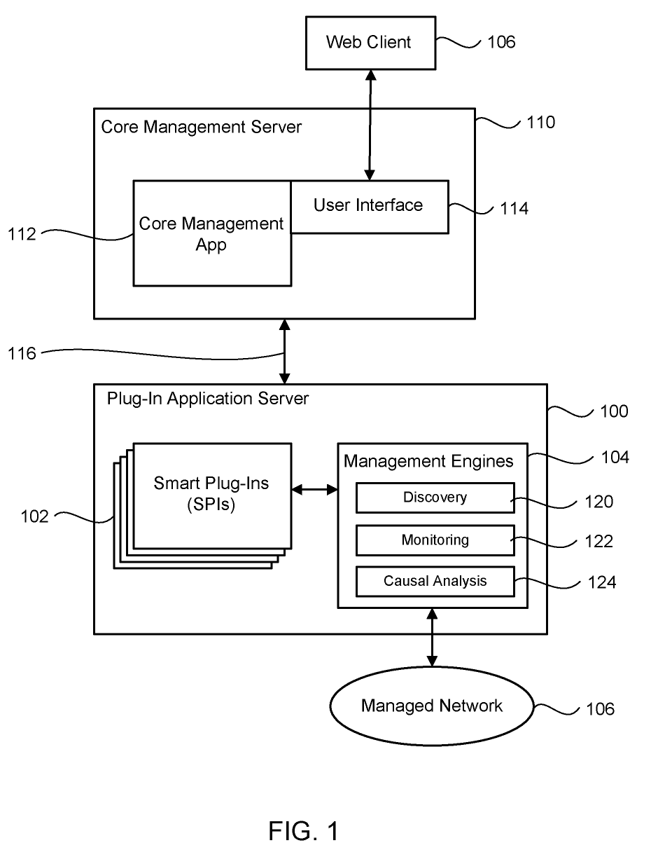

As illustrated in FIG. 1, an embodiment of an extendable distributed network management system is provided to extend a network management application and to manage a network environment. The system can include a management server 110. The management server can be an application server, web server, a client type server, a mainframe, or another type of server.

A management application 112 can reside on the management server 110, and the management application can be configured to enable a user to manage the core aspects of the network environment. The management application may be an enterprise network management software system that allows an end user or system administrator to manage computer networks of significant size through a substantially uniform user interface 114. This uniform user interface may allow the end user to use a web client or web browser 106 on a client computer to view the status of network nodes and make network changes through a consolidated interface. Using a consolidated interface helps reduce the complexity of addressing each network node or network object through its own native interface. Examples of network nodes or devices that can be managed though the network management software described can include: routers, switches, IP phones, networked printers, or other devices on a network that can communicate via management protocols such as Simple Network Management Protocol (SNMP).

The management application 112 can provide the basic network management functionality. A core data model and a persistent data store are stored on the management server. The management application can discover basic network objects that commonly exist on virtually every computer network, such as routers, switches, proxy servers, clients, and similar basic nodes. These basic network nodes can be polled about their states. In addition, the trap and incident handling along with causal analysis for the basic nodes can be provided by the management system. Causal analysis provides the root cause analysis and extracts the root cause of a problem from a series of events and conditions. However, the management application does not provide management capabilities for new, emerging, or quickly changing networking technologies due to the development cycles of additional technologies being different than the management application's development cycle and the overall complexity that might otherwise be created in the management application. Expansion for the management application functionality can be provided using extension modules 102, as described further later.

An extension application server 100 can be provided that is able to communicate with the management server 110 across a local network. Alternatively, the extension application server can also communicate with the management server via a wide area network (WAN) or through the internet. The extension application server can be a web server, a client server, mainframe, or another type of application server.

One or more of the extension modules 102 (e.g. smart plug-ins or SPIs) can be hosted on the extension application server 100. Each extension module may have its own independent application server or several extension modules can be located on the same application server. Each extension module can have its own internal data model and persistent data storage on the extension application server. The extension application server may include a web application server such as a Java web application server (e.g., the JBoss architecture) or another type of application server. Being able to distribute the extension modules between multiple extension application servers enables the overall network management system to be more scalable.

The extension modules 102 (e.g., SPIs) can supply management information and/or functions to the management application for defined network components. In other words, additional defined network management functionality can be provided using the extension modules that would not be otherwise provided with the core functionality of the management application. This enables the management of additional network objects that the management application does not have the capability to manage, and the additional network objects can be added at any time, even after the network management application has been completed. Moreover, the extension modules are content providers to the management application and the separate parts provided by the management application and the extension modules are integrated to provide a single uniform interface that can be used by an end user or system administrator.

A plurality of management engines 104 can be located on the extension application server 100. The management engines are configured to provide network probing, network device discovery, state monitoring, network event management, and causal analysis functions for the extension modules. These management engine operations can obtain network management information from the network nodes for the extension modules. The data that is supplied from the extension modules to the management application may integrate the extension modules' data object model with the management application's data object model. This means that data obtained using the management engines can be formatted into a data format that is understandable by the management application.

There are several types of management engines 104 that can be provided. These management engines are provided in the software libraries that are supplied with the development package of the network management system. This provides the extension modules with several management engines that can be utilized solely by the extension modules.

One type of management engine is a discovery engine 120 that can discover network nodes for the plurality of extension modules. In addition, the discovery engine can discover new networking aspects or technologies for network nodes already discovered by the management system. Each of the management engines can reside on the extension application server. The discovery engine can query nodes on the network on behalf of the extension module(s). Each extension module may be configured to use the discovery engine to search for the type of nodes the extension modules is programmed to manage.

Another type of management engine is a monitoring engine 122 which can be configured to monitor states of discovered network nodes for the extension modules. The monitoring engine can make requests to the network nodes that the extension modules have discovered to determine the state of the network nodes. The monitoring engine can poll nodes at scheduled intervals set by the extension module or poll a node on an ad hoc basis through a direct request from an extension module. If the state of a specialized node being monitored changes, then that information can be sent via the extension module to the management application. This state change information can then be displayed to the end user through the consolidated interface of the management application.

A causal analysis engine 124 is another of the management engines that can be used by the plurality of extension modules (e.g., SPIs or expansion objects). The analysis engine can be configured to analyze the root causes of network problems, and the causal analysis engine may be located on the extension application server. For example, the first node that is detected as having an error by the monitoring engine for the extension module may not be the root cause of the problem and status queries may be made to other dependent nodes as identified by the causal analysis engine. These causal links can be used to find the network node, device, interface, communication link, or other object that is the actual cause of the failure or problem. Analyzing the root causes of problems may be done by providing software classes that implement defined interfaces along with the appropriate configuration files (i.e., the causal rules).

An example of an extension module using the management engines is where a extension module is providing MPLS (Multi-protocol Label Switching) node management functions. The extension module can use the provided discovery engine to locate and set the status on the MPLS objects or nodes. Then the discovered data can be stored in the extension modules persistent data store. The polling engine can be used to get the current states of the MPLS objects. In addition, the causal engine can be used to set the status on the MTPLS objects and generate the appropriate error incidents.

Using these pre-existing engines for the extension modules that are part of the management application's software development kit helps promote greater consistency between all the extension modules. There can be a consistency of approach for each functional area and across content provided by different extension modules because of the use of common engines by the extension modules and the well defined integration points. Areas where overall application consistency can be improved by the present embodiments include areas such as the UI, events, discovery, polling, and the causal engine.

Each extension module can provide the services for resolving the incidents that are received from the management application. This is done by setting up a source object for an incident so that the incident on the management application is integrated with the object model provided by both the management application and the extension module. The incident processing is consistent across the network management application and the extension module and integrated with the software architecture of both the network management application and the various extension modules. For example, this type of integration can be performed by a combination of: (1) source object resolution on events (such as SNMP traps); and/or (2) extension modules can use the management server web services API (application program interface) to create new incidents that appear in the same views as incidents generated in the management server and by other extension modules. This provides a unified management platform for the overall application functionality.

In addition, each extension module provides a portion of the data for the user interface (UI) view displayed by the network management application. This data is provided in a defined format and allows the management application to display consistent and consolidated inventory views using a consistent management application object model and a conforming object model on each extension module. The core user interface (UI) can also hide the fact that there are multiple extension modules supplying information to the user interface of the management application.

An extension module 102 can provide formatted data for the user interface (UI) of the network management application 112 so the network management application can provide consistent and consolidated inventory views of network incidents across an object model used by the network management system and the extension module. In one embodiment, the extension modules' data object model is integrated into the management system. This integration is performed by setting the source object for a network incident on the network management system so that the source object is integrated with the object model for the extension module. In other words, the source object for the network management application and an extension object model can have a common format.

A communication channel 116 can be provided between the extension module 102 and the network management application 112. This channel can enable the extension module to send incident resolution and data for display via the network management application user interface (UI) over the communication channel. The extension module can also include status conclusions on extension module provided objects. Because the extension modules are directly monitoring the objects, an extension module manages using the monitoring engine. As a result, the extension module has the responsibility to supply an updated status to the network management application for network objects that the extension module is supplying to the management interface. In addition, the extension module may receive requests to the management application via the communication channel to perform user-initiated status polls. The user may activate a menu item from the user interface on the network management application to initiate status polling of a node, and then the request can be forwarded to the polling engines in each of the extension modules.

The communication between the management server and the one or more extension application servers can happen in both directions. The extension modules (through the extension application server) can make web service requests to the management server to: 1) obtain topology information for basic nodes (i.e., inventory); 2) get SNMP configuration data; 3) get incident information; and 4) register for and receive asynchronous notifications for incidents and topology events generated by the management system and other notifications (e.g., core discovery being completed on a node so that the extension module can start its additional discovery). In the other direction, the management server can make requests to the extension application server to: 1) perform incident resolution using the extension module's resolution functions; 2) get data to display in the user interface.

The communication channel 116 described above provides a loosely coupled communication interface between the management server and the extension modules. Multiple methods for communication and data access can be supported between the management server and extension application server including web services. Additional communication channel types that can be used (but are not limited to) include communications such as remote procedure calls, proprietary protocols and other network communication mechanisms. For example, the extension module may define the method of data communication and access by providing an implementation software class on the management server that implements a defined communication interface. In this sense, the extension module controls the software for the communication mechanism on both sides of the connection and this creates a loosely coupled and flexible interface. This software class may serve as the client code located on the management server for whatever communication service is provided on the extension application server. The communication interfaces and protocols for the loosely coupled interface are very flexible because the communication interfaces are defined by frameworks, templates, and/or software classes supplied by the extension module and are not dependent on the management application. This means the extension modules may change their protocols for communicating with the management server as desired by the implementation of the extension module.

The embodiments described above enable the extension modules to effectively and efficiently extend the network monitoring functions of the management application. This is due to the use of the management engines that are located on the extension application server. Locating the management engines on the management engine's own server in a distributed configuration enables the extension modules to perform their duties more quickly without drawing on the limited resources of the management application server. Thus, the management application system can be scaled-up without sacrificing the performance desired of the management application. When additional processing power is needed to monitor the network, then this additional processing power can be allocated to the extension modules and the extension application server(s).

This scalability provides a more robust and reliable solution for a network management application because complex processing for each network object type may be separated into its own extension module and even reside on its own server. So, a failure in one extension application server does not affect the other extension modules or the management application.

The separation of extension modules onto various servers allows for off-cycle development of the extension modules as compared to the network management application development cycle. This is possible because the interfaces between the extension modules and the network management application are well defined in advance. The ability to independently develop the extension modules also enables software developers to patch or upgrade the extension modules without affecting the network management application or other extension modules.

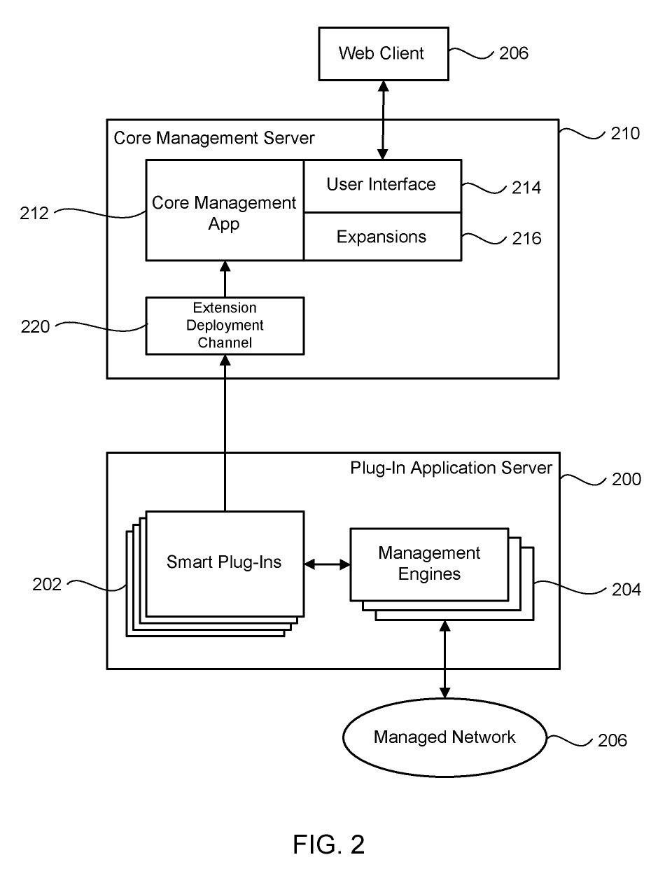

The system and method for extending a network management environment can also provide additional extension techniques for expanding the functionality of the management system. In one embodiment, the management application can receive configuration changes and extensions from the extension modules, as illustrated in FIG. 2.

As described before, a management server 210 can have resident management application 212. On a different but similarly configured extension application server 200 a plurality of extension modules 202 (e.g., smart plug-ins or SPIs) can be hosted. A plurality of management engines 204 can also be located on the extension application server. The management engines can be configured to provide network probing and debugging operations and integration of the smart plug-ins data object model with the management application's data object model.

An extension deployment channel 220 can be configured to provide extensions for the management application. The extensions may be configurable by the extension modules using an extension deployment database 220 that is loaded by the management server upon notification of a new extension or an extension update. The information used to define the extension deployment channel may take a variety of forms. For example, the extension definitions can take the form of software modules, configuration files, syntax definitions, interface definitions, or other extension definition information. The extension deployment database can be stored on the management server, on the extension application server or in another alternative location accessible to the management application.

The extension modules may also include additional configurations and/or components that can be provided for the management applications user interface (UI). For example, the extension information or extension files can provide the ability to define forms, add tabs to forms, provide additional table views, provide additional map views, define view actions, define URL (Uniform Resource Locator) actions, modify menu availability, provide additional map views, add or modify graphical workspaces, configure data views and actions, provide online help, supply additional network object icons, provide device profiles, or even instantiate new controls that are not provided with the management system. FIG. 2 illustrates these extensions 216 after the extensions are loaded into the management application.

Further, the extension deployment channel can extend the event capturing functions of the management system. The ability to extend the event capturing function further includes importing additional traps, providing incident configurations or definitions, providing incident resolvers, and resolution reference information for the functions configured to resolve respective incidents.

Extension modules can also be provided to configure the state polling and discovery for the management engines on the extension application server. For example, additional polling policies can be provided to the plug-in polling engine. More mapping rules can be provided for the plug-in discovery engine. In addition, SNMP MIB (Simple Network Management Protocol-Management Information Base) dependencies can be imported as part of the incident configuration. In addition, the extension deployment channel 220 may also support other integration types including: importing device profiles, database backup / restore, application failover configuration, status polls, etc. Many aspects of the management server can be extended by the extension modules.

In one embodiment, the extension deployment database 220 is simply one or more stored files that store the extension information with a particular file layout convention (e.g., in a text file format). For example, the extension deployment database may be a metadata file configured to store the configurations supplied through the extension deployment channel. The metadata file may contain Extensible Markup Language (XML) data used to enable configuration of the management application, or a variety of other formatting protocols that communicate the desired configurations may be used in the metadata file.

An example of a file that may store the desired extension configurations can be where an extension deployment database is a file containing mixed objects such as XML objects, Java object classes, JPGs, and other types of files configured to enable the management application to communicate with the extension modules. The file may use an .nnm suffix and the format of the file can be a file containing multiple compressed objects (e.g. .jar or .zip type), so the extension deployment database can contain any kind of file. The overall structure of the extension deployment database file is pre-defined to allow orderly extension of different parts of the management application (e.g., NMS). The use of a file containing actual object classes may allow entirely new user interfaces classes to be loaded by the management applications and these new interfaces can be displayed in locations in the management application that have been left open by the management application as being extendable by the extension modules. Alternatively, existing user interface objects can just be modified or extended by the extension deployment database. In addition, the extension deployment database can provide event and polling extensions.

The extensions described can result in the complex network management content being provided in an extensible way. In addition, a combination of multiple instances of application servers each provide an inter-operable data model, data persistence, network node discovery, state monitoring for network nodes, and causal analysis for network nodes. The deployable extensions allow flexible extensions to the management application to be used, which provide dynamic configuration of user interfaces (UIs) and event integration. In addition, the network management application can integrate content from multiple sources across all functional areas (UI, events, discovery, polling and causal analysis) in a consistent and unified manner.

Another result of the present system and method is that the versatile model for the extension modules provides flexibility in how the extension modules implement their functions for the network management application. For example, a variety of application server types can be used for hosting the extension modules or the management application. In addition, a variety of data persistence solutions can be used to store the extension modules data. For example, the commercial products such as Hibernate, EJB (Enterprise Java Beans), or other data storage software can be used.

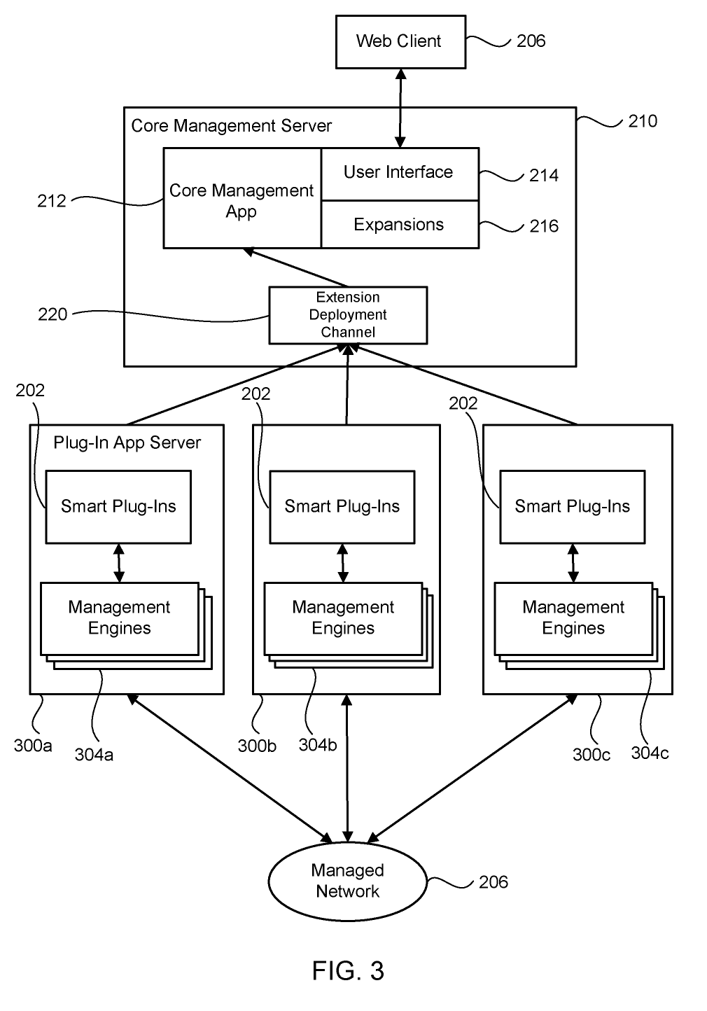

FIG. 3 is a block diagram illustrating an extendable distributed network management system where each extension module 300a-300c (i.e., SPI) is located on a separate extension application server. Each extension application server hosting an extension module 302a-c can also host a separate instance of the management engines 304a-c for use by the extension module on the extension application server. The management engines on each extension application server can include a discovery engine, a polling engine, and a causal engine, as discussed in detail above. The elements in FIG. 3 that have the same numbering as FIG. 2 operate in a similar manner as described in FIG. 2 but with the ability to interface with multiple extension application servers 302a-c (e.g., SPI servers).

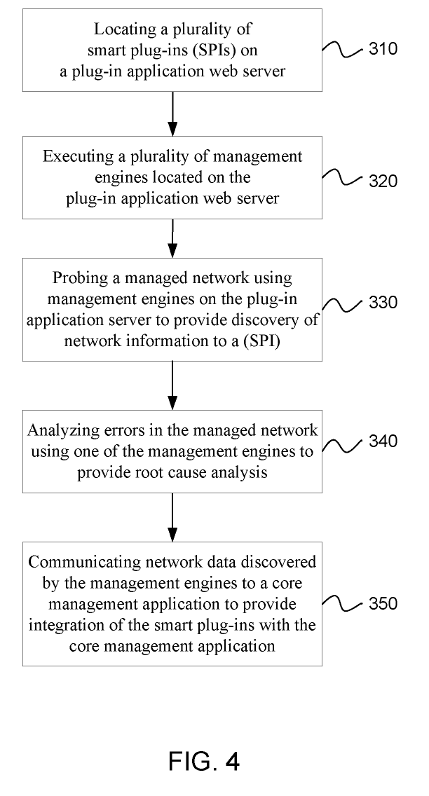

FIG. 4 illustrates a method of extending a network management environment, which summarizes the operations of the present system. The method includes the operation of executing a plurality of extension modules (e.g., SPIs) on an extension application server, as in block 410. The extension module can be executing on an extension application server. In addition, a plurality of management engines can also be executing on the extension application server, as in block 420.

A managed network can then be probed using one of the management engines on the extension application server to provide discovery of network information to a requesting extension module, as in block 430. An extension module can use the discovery engine to search for specific types of nodes that the extension module is managing.

Errors in the managed network can then be analyzed using one of the management engines to provide root cause analysis to a requesting extension module (e.g., smart plug-in or SPI), as in block 340. Specifically, the plug-in causal analysis engine can be used. Since the analysis engine is located on the same application server as the extension module, these resources are located together. The states of discovered network nodes for the extension modules can be monitored using a plug-in monitoring engine located on the extension application server. An application server may also include a web server, a web application server, web services, EJB (Enterprise Java Beans) and/or other communication channels for supplying network enabled applications.

The network data discovered by the management engines can be communicated to a management application residing on a management server via at least one smart plug-in. The transfer of the network data can provide integration of the extension modules data object model with the management application's data object model, as in block 450. More specifically, there is UI integration of the extension module data with the management application data, so that the resulting output appears to be unified and integrated. The extension module data model can refer to the core data model, but generally not vice versa. In one embodiment there is no database-level integration of data and the extension module has its own database.

The present system and method has been described as using multiple extension application servers or multiple extension modules on a single server to support one management server. However, in one embodiment, the present system may also use one extension module to support multiple management applications within a network.

Because the embodiments described herein provide common engines along with the network management system for discovery, polling and analysis, this makes it easier to develop extension modules as opposed to developing the complex engine technology for each extension module. In addition, the extension modules rely on the network management system to provide the user interface and event functionality. This leaves the extension module with the smaller job of just integrating with the management application using the well-defined extension points. The system also has reduced complexity because there is not just a single rigid data model or tightly-coupled implementation. These system configurations reduce the overall cost of the extension modules and finally the total system cost.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. An extendable distributed network management system configured to manage a network environment, comprising:
a management server;
a management application residing on the management server, and the management application being configured to enable a user to manage the network environment;
an extension application server;
a plurality of extension modules configured to be hosted on the extension application server, the extension modules being configured to supply management functions to the management application for identified network components; and
a plurality of management engines located on the extension application server, wherein the management engines are configured to provide network probing and network event management while integrating an extension modules' data object model with a management application's data object model.

2. A system as in claim 1, wherein one of the plurality of management engines further comprises a discovery engine configured to provide discovery of network nodes for an extension module, and the discovery engine resides on the extension application server.

3. A system as in claim 1, wherein one of the plurality of management engines further comprises a monitoring engine configured to monitor states of discovered network nodes for an extension module, and the monitoring engine is located on the extension application server.

4. A system as in claim 1, wherein one of the plurality of management engines further comprises a causal analysis engine configured to analyze root causes of network problems for an extension module, and the causal engine is located on the extension application server.

5. A system as in claim 1, wherein an extension module's data object model is integrated into the management application by setting a source object for an incident on the management application so that the source object is integrated with the management application data object model for the extension module.

6. A system as in claim 1, wherein the extension module provides formatted data for a user interface (UI) of the network management application so the network management application can provide consistent and consolidated inventory views across an object model used by the management application and the extension module.

7. A system as in claim 1, further comprising a communication channel between the extension module and the management application, wherein incident resolution and data for display on a network management application user interface (UI) are sent by the extension module over the communication channel.

8. A system as in claim 1, wherein the extension modules are smart plug-ins (SPIs).

9. A system as in claim 1, further comprising defined extension channels for the management application that are configured to provide extensions for UI generation and event processing.

10. A method of extending a distributed network management system, comprising the steps of:
executing a plurality of extension modules on an extension application server;
executing a plurality of management engines located on the extension application server;
probing a managed network using one of the plurality of management engines on the extension application server in order to supply discovery of network information to a requesting extension module;
analyzing errors in the managed network using one of the plurality of management engines to provide root cause analysis to a requesting extension module; and
communicating network information discovered by the management engines to a management application residing on a management server via an extension module in order to provide integration of the requesting extension module's data object model with a management application's data object model.

11. A method as in claim 11, further comprising the step of monitoring states of discovered network nodes for the extension modules using a plug-in monitoring engine located on the extension application server.

12. A method as in claim 11, further comprising the step of analyzing root causes of network problems for the plurality of extension modules using a plug-in causal analysis engine located on the extension application server.

13. A method as in claim 11, further comprising the step of discovering network nodes for the plurality of extension modules using a discovery engine located on the extension application server.

14. A method as in claim 11, further comprising the step of integrating the extension modules' data object model into a network management application by setting a source object for incidents on the network management application using the extension module.

15. An extendable distributable network management system, comprising:
a management server;
a management application residing on the management server;
a extension application server;
a plurality of extension modules configured to be hosted on the extension application server;
a plurality of management engines located on the extension application server, wherein the management engines are configured to provide network probing and debugging operations and integration of an extension module's data object model with a management application's data object model; and
an extension deployment channel configured to provide extensions for the management application that are configurable by the extension module using an extension deployment database loaded by the management application.

16. A system as in claim 15, wherein the extension deployment database is a meta data file configured to store a configuration for the extension deployment channel.

17. A system as in claim 15, wherein the extension deployment database is a file containing an object class configured to enable the management application to communicate with the extension modules.

18. A system as in claim 15, wherein the extension deployment channel extends the user interface (UI) of the management application.

19. A system as in claim 15, wherein the extension deployment channel extends an event capturing function of a management application.

20. A system as in claim 19, wherein an ability to extend the event capturing function further comprises importing trap and incident configurations and resolution reference information for a function configured to revolve respective incidents.
